(19) United States
(12) Patent Application Publication
(10) Pub. No.: US 2026/0115098 A1
(43) Pub. Date: Apr. 30, 2026

(54) Therapeutic Spa Bath for Providing Hydrotherapy Treatments

(71) Applicant: Sean Thomas, Fort Wayne, IN (US)

(72) Inventor: Sean Thomas, Fort Wayne, IN (US)

(21) Appl. No.: 18/925,130

(22) Filed: Oct. 24, 2024

(51) Int. Cl. A61H 33/00

(52) U.S. Cl. CPC A61H 33/6063; A61H 33/6047; A61H 2201/0207; A61H 2201/1604; A61H 2201/1623; A61H 2201/1635; A61H 2201/164; A61H 2203/0437; A61H 2205/081

(57) ABSTRACT

A spinal traction/decompression therapy treatment can be performed using a therapeutic spa bath. The therapeutic spa bath can comprise a bathtub body having a central reservoir which can be filled with water. The bathtub body can include a floor, a backrest, a headrest, an upstanding sidewall, and a pair of leg cover shelves extending over the floor. A plurality of water jet nozzles can be mounted to the backrest, the headrest, the floor, and the leg cover shelves and a water pump can be operably coupled to the water jet nozzles by one or more conduits. In operation, the water pump provides pressurized water to the water jet nozzles for generating massaging water jets within the reservoir which provide the spa bath user with a hydromassage and gently pull the spa bath user's torso and head in opposite directions for providing a gentle spinal traction/decompression therapy treatment.

### BACKGROUND OF THE INVENTION

### 1. Field of the Invention

The present invention relates to spa baths used for providing physical therapy treatments. More particularly, the present invention is directed to a therapeutic spa bath for providing hydrotherapy treatments including gentle spinal traction/decompression therapy, hydromassage therapy, and heat therapy treatments.

### 2. Background

In general, therapeutic spa baths are used to provide hydromassage and heat therapies. These spa baths typically include a bathtub-shaped body, commonly referred to as the “shell”, a plurality of jet nozzles that are mounted to the body, a pump that supplies pressurized water to the jet nozzles, and a water heater that warms the water supplied to the jet nozzles. The body typically includes a floor and an upstanding wall that together define a reservoir that contains the water used for hydromassage and heat therapies. The body typically also includes a seat for the user and one or more inlets formed in the body floor and/or the upstanding wall that supply water to the pump. The jet nozzles can be mounted to the body floor, the upstanding wall, and/or the seat and are generally positioned to direct a massaging water flow at portions of the user's body.

In operation, the user climbs into the spa bath and partially or fully submerges themselves in the water contained therein. When the user is comfortably positioned, the water pump can be activated for generating massaging water jets which are used to massage portions of the user's body as part of a hydromassage therapy treatment. Additionally, the water heater can be used both before the user climbs into and while the user is resting within the spa bath to heat the bath water to a desired temperature and to maintain the desired temperature while the user is resting within the spa bath. Typically, the water heater is configured to heat the water to between 80 and 104 degrees for providing a heat therapy treatment.

Existing therapeutic spa baths, however, do not provide spinal traction/decompression therapy treatments and are not configured to provide hydromassage therapy treatments to the front, back, and sides of the user's body simultaneously. Accordingly, there exists a need for an improved therapeutic spa bath.

### SUMMARY OF THE INVENTION

In the present invention, a method of providing a spinal traction/decompression therapy treatment can be performed using a therapeutic spa bath. The therapeutic spa bath can comprise a bathtub body having a central reservoir which can be filled with water. The bathtub body can include a floor, a backrest, a headrest, and an upstanding sidewall, and the reservoir can be defined between the floor, backrest, headrest, and upstanding sidewall. A first plurality of water jet nozzles can be mounted to the backrest, a second plurality of water jet nozzles can be mounted to the headrest, and a water pump can be operably coupled to the first and second pluralities of water jet nozzles by one or more conduits. In operation, the water pump provides pressurized water to the first and second pluralities of water jet nozzles through the conduits for generating massaging water jets within the reservoir.

The method of performing the spinal traction/decompression therapy treatment can comprise the steps of positioning a spa bath user within the reservoir, wherein the spa bath user's head is positioned adjacent to the headrest and the spa bath user's torso is positioned adjacent to the backrest, and activating the water pump for generating massaging water jets within the reservoir. When the water pump is activated, the massaging water jets generated by the first plurality of water jet nozzles gently pull the spa bath user's torso in a first direction and the second plurality of water jet nozzles gently pull the spa bath user's head an opposite second direction for providing a gentle spinal traction/decompression therapy treatment.

Preferably, the spa bath user is floatingly supported within the reservoir and experiences reduced gravitational forces which facilitates the spinal traction/decompression therapy treatment.

Preferably, the therapeutic spa bath can further include a water heater unit which can be operably coupled to the water pump by one or more conduits. The water heater unit can be used to heat the water within the reservoir for providing a heat therapy treatment.

In another embodiment of the present invention, a therapeutic spa bath for providing a spinal traction/decompression therapy treatment can comprise a floor, a backrest, a headrest, an upstanding sidewall, a reservoir defined between the floor, upstanding sidewall, backrest, and headrest, a first plurality of water jet nozzles mounted to the backrest, a second plurality of water jet nozzles mounted to the headrest, and a water pump operably coupled to the water jet nozzles by one or more conduits. In operation, the spa bath user is positioned within the reservoir with the spa bath user's head adjacent to the headrest and the spa bath user's torso adjacent to the backrest. The water pump can then be activated for providing pressurized water to the water jet nozzles through the conduits and generating massaging water jets within the reservoir. When the water pump is activated, the massaging water jets generated by the first plurality of water jet nozzles gently pull the spa bath user's torso in a first direction and the second plurality of water jet nozzles gently pull the spa bath user's head an opposite second direction for providing a gentle spinal traction/decompression therapy treatment.

In another embodiment of the present invention, a therapeutic spa bath for providing one or more hydrotherapy treatments can comprise a floor, a backrest, a headrest, an upstanding sidewall, a reservoir defined between the floor, upstanding sidewall, backrest, and headrest, a pair of leg cover shelves extending over the floor adjacent to a first end of the therapeutic spa bath, a plurality of water jet nozzles, wherein one or more of the water jet nozzles are mounted to the floor beneath the leg cover shelves and one or more water jet nozzles are mounted to the leg cover shelves above the floor, and a water pump operably coupled to the water jet nozzles by one or more conduits. In operation, the water pump provides pressurized water to the water jet nozzles through the conduits for generating massaging water jets within the reservoir.

Preferably, the massaging water jets generated by the water jet nozzles mounted to the leg cover shelves flow generally downwardly towards the floor and the massaging water jets generated by the water jet nozzles mounted to the floor beneath the leg cover shelves flow generally upwardly towards the leg cover shelves.

Preferably, the therapeutic spa bath further comprises a pair of armrests formed one on either side of the reservoir and a pair of arm cover shelves which extend one over each of the armrests. One or more water jet nozzles can be mounted to each armrest and one or more water jet nozzles can be mounted to each arm cover shelf. Yet more preferably, the water jet nozzles mounted to the armrests generate massaging water jets which flow generally upwardly towards the arm cover shelves and the water jet nozzles mounted to the arm cover shelves flow generally downwardly towards the armrests.

Preferably, one or more of the water jet nozzles are mounted to the sidewall vertically between the floor and each of the leg cover shelves and one or more of the water jet nozzles are mounted to the sidewall vertically between the armrest and each of the arm cover shelves.

Preferably, the therapeutic spa bath further comprises an inner leg jet wall which extends upwardly from the floor and extends generally longitudinally along a centerline of the reservoir. One or more of the water jet nozzles can be mounted to the inner leg jet wall and can be configured to generate massaging water jets which flow at an angle generally upwardly and horizontally towards a longitudinal side of the reservoir.

In another embodiment of the present invention, a method of providing a hydromassage therapy treatment can be performed using a therapeutic spa bath. The therapeutic spa bath can comprise a floor, a backrest, a headrest, an upstanding sidewall, a reservoir defined between the floor, upstanding sidewall, backrest, and headrest, said reservoir filled with water, a pair of leg cover shelves extending over the floor adjacent to a first end of the therapeutic spa bath, a plurality of water jet nozzles, wherein one or more of the water jet nozzles are mounted to the floor beneath the leg cover shelves and one or more water jet nozzles are mounted to the leg cover shelves above the floor, and a water pump operably coupled to the water jet nozzles by one or more conduits. In operation, the water pump provides pressurized water to the plurality of water jet nozzles through the conduits for generating massaging water jets within the reservoir.

The method can comprise the steps of positioning a spa bath user within the reservoir with the spa bath user's legs positioned between the water jet nozzles mounted to the floor and the water jet nozzles mounted to the leg cover shelves and activating the water pump for generating massaging water jets within the reservoir, wherein the massaging water jets generated by water jet nozzles mounted to the floor provide a hydromassage therapy treatment to a first side of the spa bath user's legs and the water jet nozzles mounted to the leg cover shelves provide a hydromassage therapy treatment to a second side of the spa bath user's legs.

Preferably, the therapeutic spa bath further comprises an inner leg jet wall which extends upwardly from the floor and extends generally longitudinally along a centerline of the reservoir, wherein one or more of the water jet nozzles are mounted to the inner leg jet wall. The massaging water jets generated by the water jet nozzles mounted to the inner leg jet wall can be used to provide a hydromassage therapy treatment to a third side of the spa bath user's legs.

Preferably, the therapeutic spa bath further comprises a pair of armrests formed one on either side of the reservoir and a pair of arm cover shelves which extend one over each of the armrests, wherein one or more water jet nozzles are mounted to each armrest and one or more water jet nozzles are mounted to each arm cover shelf. The massaging water jets generated by the water jet nozzles mounted to the armrest can be used provide a hydromassage therapy treatment to a first side of the spa bath user's arms and the massaging water jets generated by the water jet nozzles mounted to the arm cover shelves can be used to provide a hydromassage therapy treatment to a second side of the spa bath user's arms.

Preferably, the water pump is selectively adjustable for increasing or decreasing an intensity of the massaging water jets generated within the reservoir. Yet more preferably, the water pump is selectively adjustable for increasing or decreasing an intensity of the massaging water jets generated by the water jet nozzles mounted to the floor, the leg cover shelves, the armrests, and the arm cover shelves independently from each other.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of a therapeutic spa bath;

FIG. 2 is another perspective view of the therapeutic spa bath wherein a portion of the body has been removed to show the interior of the spa bath;

FIG. 3A is a top plan view of the therapeutic spa bath;

FIG. 3B is a magnified detail view of Circled Detail 3B shown in FIG. 3A;

FIG. 4 is a cross-section view of the therapeutic spa bath taken along the line 4-4 shown in FIG. 3A;

FIG. 5 is a cross-section view of the therapeutic spa bath taken along the line 5-5 shown in FIG. 4;

FIG. 6 is a magnified detail view of Circled Detail 6 shown in FIG. 4;

FIG. 7 is a magnified detail view of Circled Detail 7 shown in FIG. 4;

FIG. 8 is a cross-section view of the therapeutic spa bath taken along the line 8-8 shown in FIG. 4;

FIG. 9 is a cross-section view of the therapeutic spa bath taken along the line 9-9 shown in FIG. 4;

FIG. 10 is a cross-section view of the therapeutic spa bath taken along the line 10-10 shown in FIG. 4;

FIG. 11 is a block diagram of an exemplary massaging jet system for a therapeutic spa bath having a single water pump unit and a plurality of control valves; and

FIG. 12 is a block diagram of an exemplary massaging jet system for a therapeutic spa bath having a plurality of water pump units.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

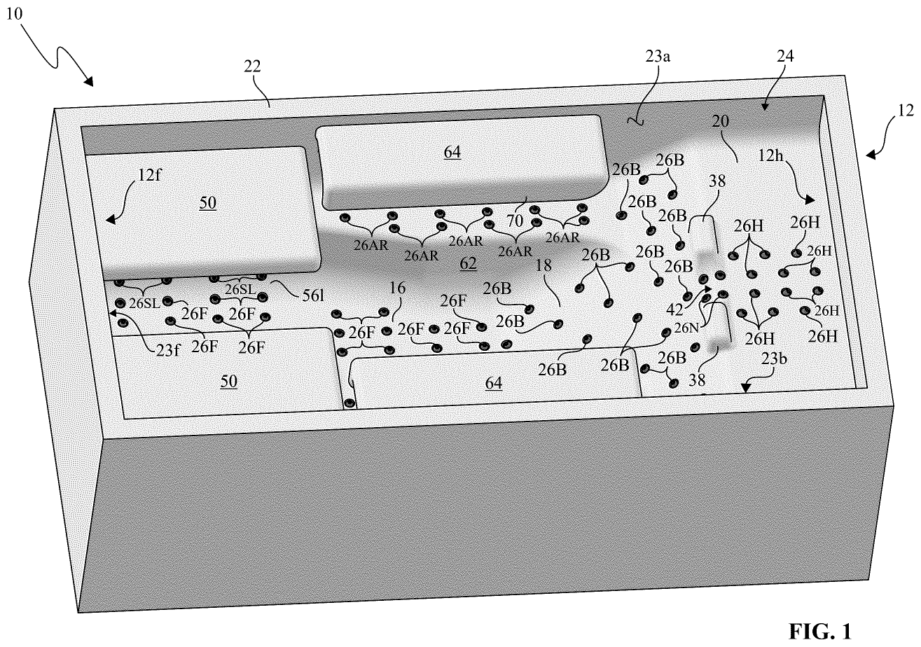

As shown in FIGS. 1-5, a therapeutic spa bath constructed in accordance with the principles of the present invention is shown and designated by the numeral 10. The therapeutic spa bath 10 is adapted to provide one or more hydrotherapy treatments for rehabilitating or treating injuries. More particularly, the therapeutic spa bath 10 is adapted to provide hydrotherapy treatments, including, for example, a gentle spinal traction/decompression therapy treatment, a hydromassage therapy treatment, and a heat therapy treatment, which can be used for rehabilitating or treating injuries including, for example, sport injuries such as golfers and tennis elbow, disc herniation, and overuse injuries.

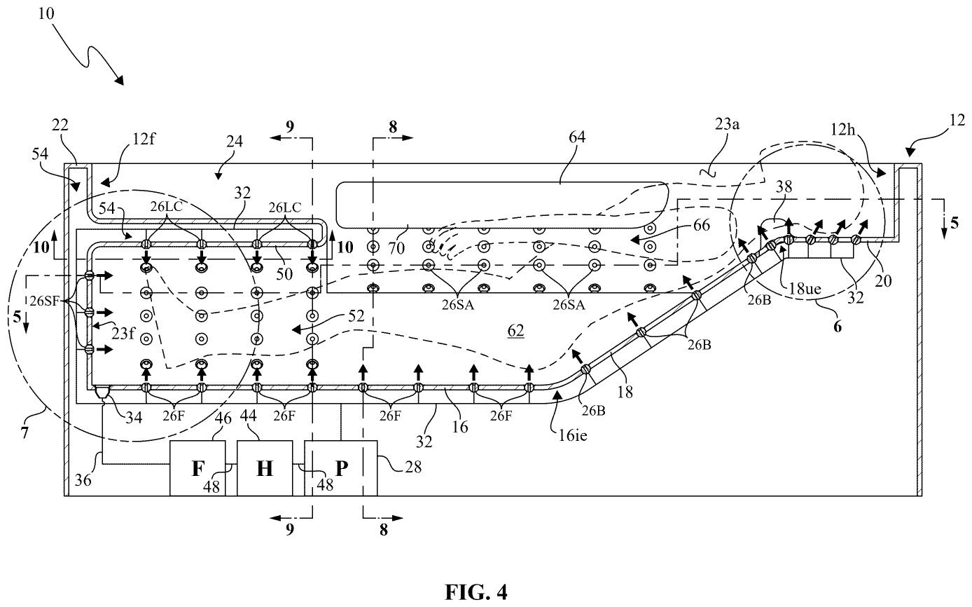

The spa bath 10 includes a bathtub-shaped body 12 and a massaging jet system 14. The body 12, commonly referred to as the “shell”, includes a floor section 16, a backrest section 18, a headrest section 20, an upstanding sidewall 22, and a central reservoir 24 that is filled with water. As best seen in FIG. 4, the floor section 16 extends horizontally from a foot end 12f of the body 12 towards a head end 12h of the body. The backrest section 18 slopes upwardly from the inboard end 16ie of the floor section 16 towards the head end 12h of the body. The headrest section 20 extends horizontally between the head end 12h of the body and the upper end 18ue of the backrest section 18. The upstanding sidewall 22 extends vertically upwardly from and along the perimeter edges of the floor section 16, backrest section 18, and headrest section 20. Together, the floor section 16, the backrest section 18, the headrest section 20, and the upstanding sidewall 22 define the central reservoir 24.

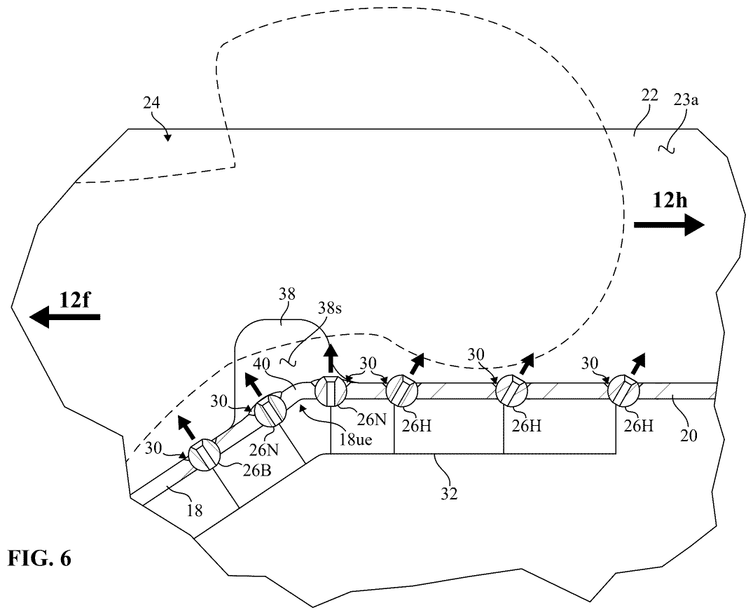

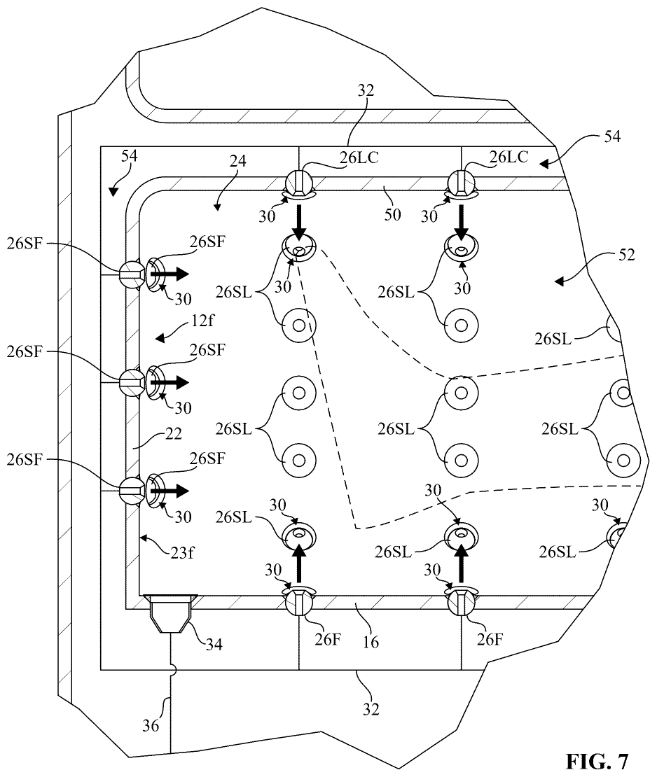

The massaging jet system 14 includes a plurality of jet nozzles 26 and a water pump unit 28. The jet nozzles 26 are mounted to the floor section 16, backrest section 18, and headrest section 20 and can be, for example, commercially available directional jet nozzles that are commonly used in therapeutic spa baths and/or hot tubs. For illustrative purposes, the jet nozzles 26 are shown as spherical jet nozzles which are mounted within sockets 30 formed in the floor section 16, backrest section 18, and headrest section 20 (see e.g., FIGS. 6 and 7). The water pump unit 28 is connected to the jet nozzles 26 by a plurality of jet conduits 32 and can be, for example, an electric water pump unit comprising a water pump 28p driven by an electric motor 28m and/or other commercially available water pump units that are commonly used in therapeutic spa baths and/or hot tubs.

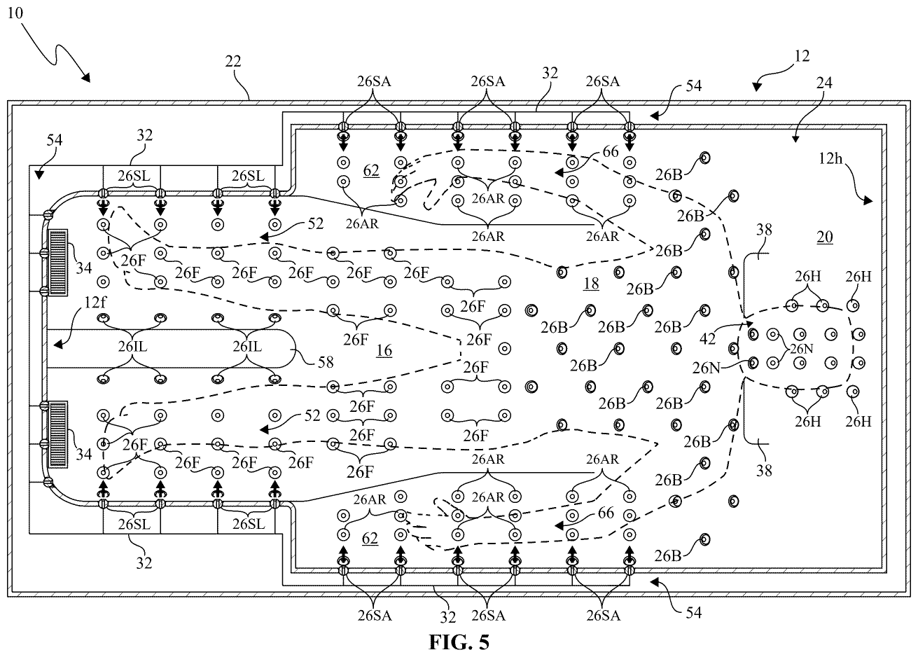

The water pump unit 28 is also connected by intake conduits 36 to one or more intake fittings 34 which are preferably mounted to the floor section 16. When the water pump unit 28 is activated, water is pulled from the reservoir through the intake fittings 34 and the intake conduits 36 to the water pump unit 28. The water pump unit 28 then pressurizes and pumps the water through the jet conduits 32 to the jet nozzles 26 for generating massaging water jets within the central reservoir 24. For illustrative purposes, the massaging water jets are shown in FIGS. 5-9 as arrows which point in the general flow direction of the water jet.

The jet nozzles 26 are positioned to direct the massaging water jets at selectively desired portions of the spa bath user's body. Specifically, the jet nozzles 26 mounted to the floor section 16 (referred to hereafter as the floor jet nozzles 26F) are positioned to direct massaging water jets towards the back of the spa bath user's calves and thighs, the jet nozzles 26 mounted to the backrest section 18 (referred to hereafter as the backrest jet nozzles 26B) are positioned to direct massaging water jets towards the spa bath user's back and shoulders, and the jet nozzles 26 mounted to the headrest section 20 (referred to hereafter as the headrest jet nozzles 26H) are positioned to direct massaging water jets towards the back of the spa bath user's neck and head.

Preferably, the jet nozzles 26 are arranged in regularly spaced patterns for evenly distributing the massaging water jets across the spa bath user's body. For example, as best seen in FIG. 5, the floor jet nozzles 26F can be arranged in regularly spaced rows and columns for distributing massaging water jets across the back of the spa bath user's legs. As another example, the backrest jet nozzles 26B can be arranged in staggered rows and columns for distributing massaging water jets across the spa bath user's back and shoulders. The jet nozzles 26 can also be arranged in any number of other patterns and arrangements as may be necessary or desirable.

In operation, the spa bath user is positioned within the reservoir 24 with their legs resting on top of the floor section 16, their back and shoulders resting against the backrest section 18, and their head resting on top of the headrest section 20. As mentioned above, when the water pump unit 28 is activated, pressurized water is pumped to the jet nozzles 26 for generating the massaging water jets. These massaging water jets massage the bath user's legs, back, shoulders, neck, and head for providing a hydromassage therapy treatment.

Preferably, the water pump unit 28 is selectively adjustable for allowing the user to selectively increase and/or decrease the output pressure of the water pump unit 28 and thereby increase and/or decrease the intensity of the massaging waters jets as may be necessary or desirable. Yet more preferably, the intensity of the massaging water jets is configured to lift and support the spa bath user slightly vertically upwardly such that the spa bath user is floatingly supported within the reservoir 24 (FIG. 4).

Additionally, the backrest jet nozzles 26B and the headrest jet nozzles 26H are preferably configured to generate massaging water jets that flow in opposite directions for providing a gentle spinal traction/decompression therapy treatment. More particularly, spinal traction/decompression therapy treatments typically comprise stretching and elongating the patient's neck and spine to relieve pressure thereon. Relieving pressure on the spine can help to reduce back pain from conditions such as, for example, sciatica, herniated discs, spinal stenosis, pinched nerves, etc., and is particularly helpful as a non-surgical treatment for such conditions.

In the present invention, as best seen in FIG. 6, the backrest jet nozzles 26B are configured to generate massaging water jets that flow generally vertically upwardly and towards the foot end 12f of the body 12. The headrest jet nozzles 26H, on the other hand, are configured to generate massaging water jets that flow generally vertically upwardly and towards the head end 12h of the body 12. In operation, the massaging water jets generated by the headrest jet nozzles 26H gently pull the bath user's head towards the head end 12h of the body 12 and the massaging water jets generated by the backrest jet nozzles 26H gently pull the user's torso in the opposite direction towards the foot end 12f of the body. These gentle pulling forces help to stretch and decompress the spa bath user's neck and spine for providing a gentle spinal traction/decompression therapy treatment. Additionally, as mentioned above, the spa bath 10 is preferably configured such that the spa bath user is generally floating within the reservoir 24. This reduces the gravitational forces experienced by the spa bath user and helps to further decompress the user's neck and spine.

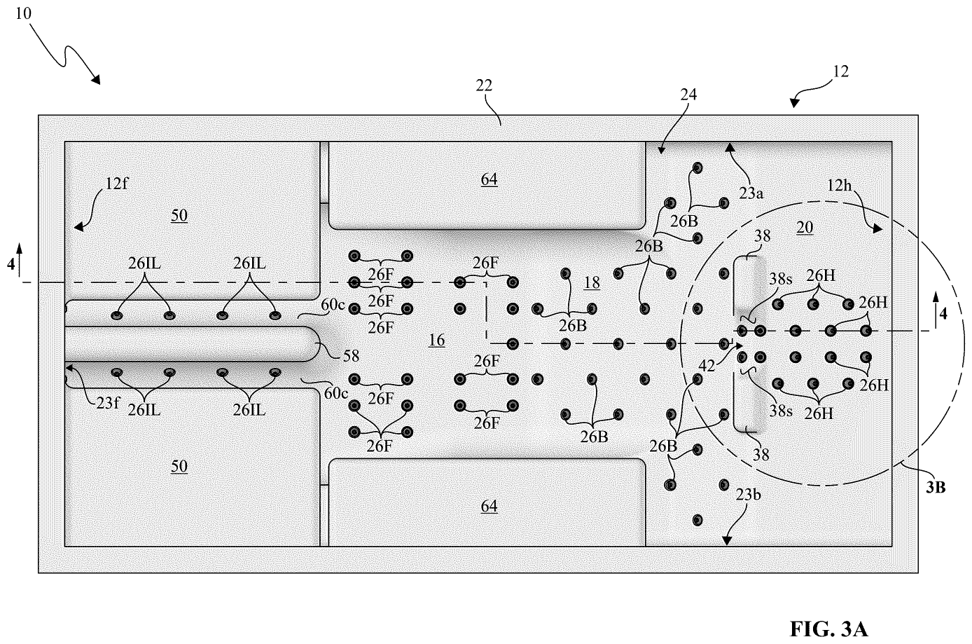

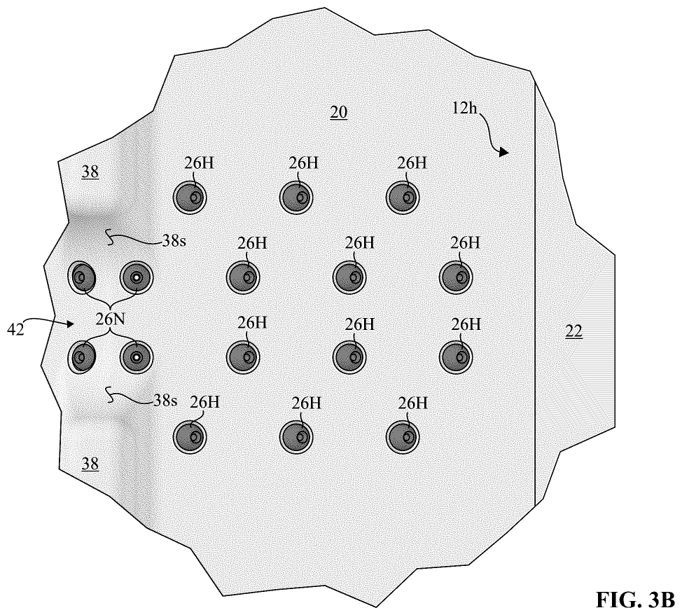

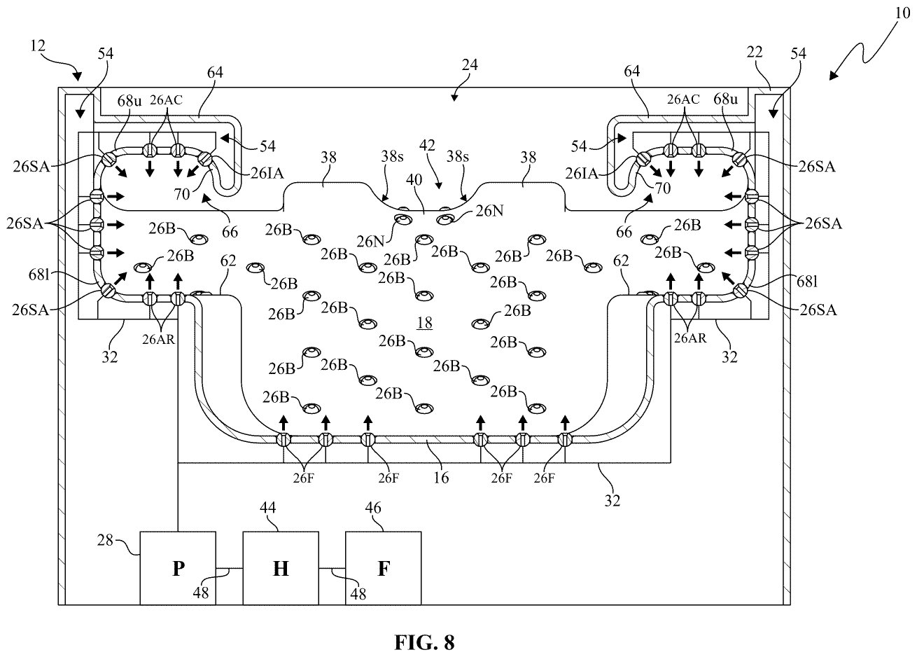

To ensure spa bath user is properly positioned for the spinal traction/decompression therapy treatment, the spa bath 10 preferably includes a pair of neck pads 38. The neck pads 38 are positioned along the corner section 40 (FIGS. 3A and 6) formed between the backrest section 18 and the headrest section 20 and can be integrally formed with the body 12 or attached to the body 12 via fasteners or other attachment means (not shown). As best seen in FIG. 8, the neck pads 38 are spaced horizontally apart from each other and form a neck cradle 42 therebetween for receiving the bath user's neck. In operation, the user is positioned with their neck received into and resting against the neck cradle 42. When the massaging jet system 14 is activated, the neck pads 38 help keep the bath user's head aligned with the headrest jet nozzles 26H.

Preferably, the neck pads 38 each include sloped side surfaces 38s that face towards the other neck pad 38. As best seen in FIGS. 3B and 8, the sloped side surfaces 38s define the sides of the neck cradle 42 and are preferably contoured such that neck receiving cradle 42 does not include any hard edges. Additionally, the neck pads 38 can be constructed from a soft, cushion-like material such as, for example, a compressible foam material wrapped in a fabric material. Contouring the sloped side surfaces 38s to eliminate hard edges and constructing the neck pads 38 from a soft, cushion-like material prevents the neck pads 38 from scraping against the user's neck and improves comfort during use of the spa bath 10.

As best seen in FIGS. 3B and 6, the spa bath 10 preferably also includes jet nozzles 26 that are mounted to the body 12 within the neck cradle 42 (referred to hereafter as the neck jet nozzles 26N). The neck jet nozzles 26N are configured to generate massaging water jets which are directed at the bath user's neck for providing hydromassage therapy thereto. The neck jet nozzles 26N also help to support the bath user's neck and head slightly above the neck cradle 42 and headrest section 20 for further improving comfort during use of the spa bath 10.

Preferably, as diagrammatically shown in FIGS. 4, 8, 9, 11, and 12, the massaging jet system 14 also includes a water heater unit 44 and a water filter unit 46 which are connected to the water pump unit 28 by auxiliary conduits 48. The water heater unit 44 can be, for example, a commercially available water heater unit that is commonly used in therapeutic spa baths and/or hot tubs. The water filter unit 46 can be, for example, an ultraviolet filter system, an ozone purification system, and/or other commercially available water filtration and/or decontamination units that are commonly used in therapeutic spa baths and/or hot tubs. In use, the water heater unit 44 heats the spa bath water for providing a heat therapy treatment and the water filter unit 46 filters and decontaminates the water as it travels through the massaging jet system 14. Preferably, the water heater unit 44 is configured to heat the spa bath water to a temperature of, for example, between approximately 80 and 104 degrees Fahrenheit.

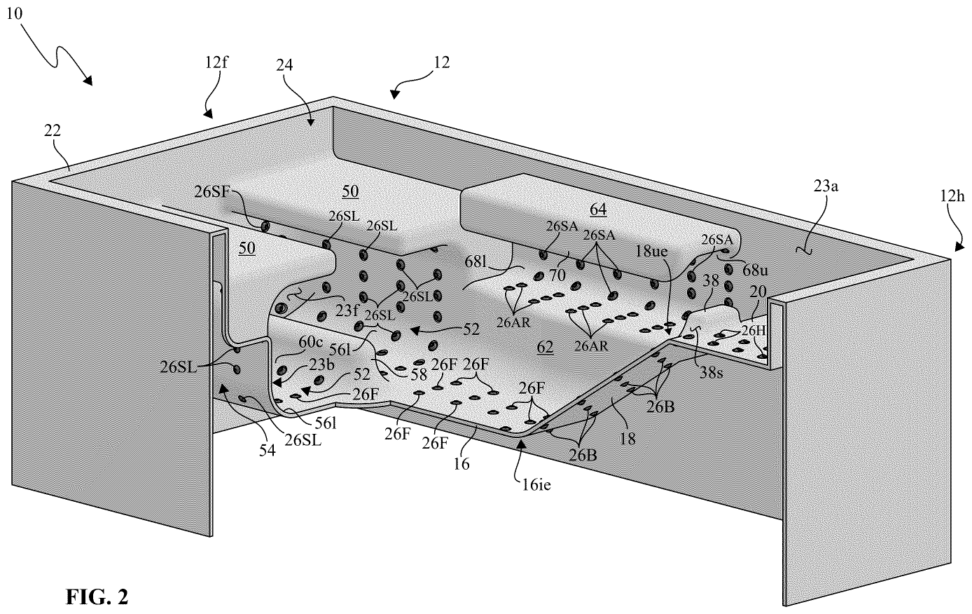

Turning to FIGS. 2, 4, 9, and 10, the spa bath 10 preferably also includes a pair of leg cover shelves 50 which can be integrally formed with or attached to the body 12. The leg cover shelves 50 extend horizontally inwardly from the longitudinal side surfaces 23a, 23b of the upstanding sidewall 22 and are located vertically above the floor section 16 adjacent to the foot end 12f of the body 12 whereby a pair of C-shaped leg receiving channels 52 are defined between the leg cover shelves 50, the sidewall 22, and the floor section 16. In use, the spa bath user's legs are received one into each of the leg receiving channels 52.

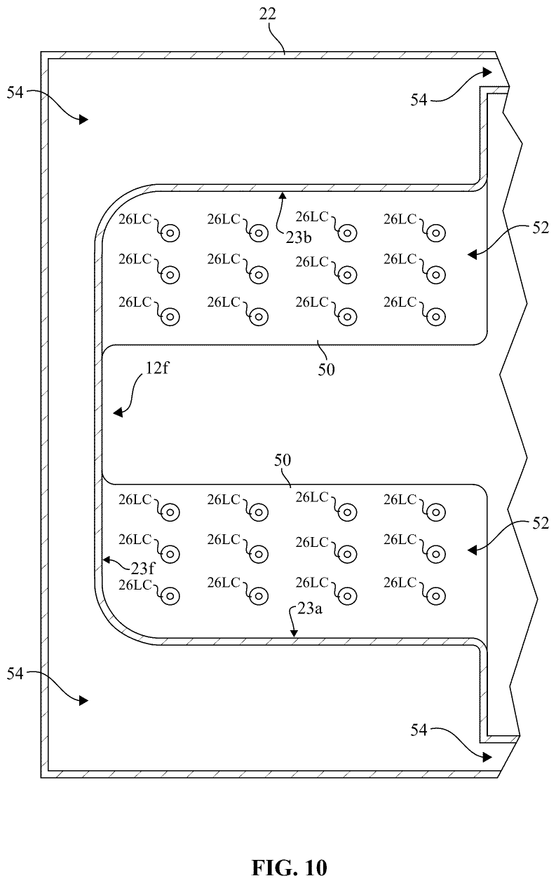

As best seen in FIG. 10, a plurality of jet nozzles 26 are mounted to the leg cover shelves 50 (referred to hereinafter as the leg cover jet nozzles 26LC). The leg cover jet nozzles 26LC are positioned to direct massaging water jets downwardly towards the front of the spa bath user's legs and can be arranged in, for example, regularly space rows and columns. Additionally, the spa bath 10 preferably also includes a plurality of jet nozzles 26 (referred to hereinafter as the sidewall leg jet nozzles 26SL) which are mounted to the sidewall 22 in the spaces between the floor section 16 and the leg cover shelves 50. The sidewall leg jet nozzles 26SL are positioned to direct massaging water jets horizontally towards the outer sides of the spa bath user's legs and can also be arranged in regularly spaced rows and columns.

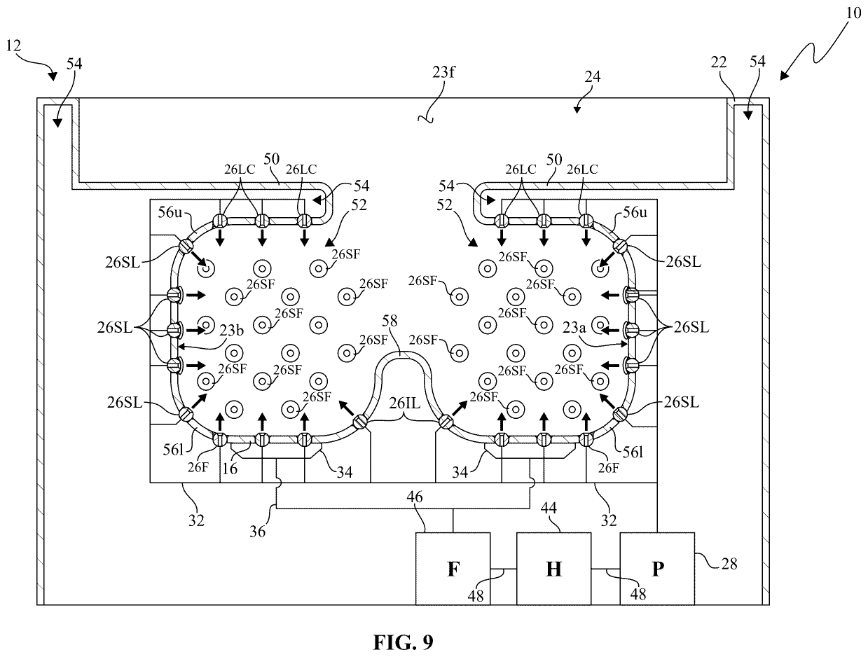

Preferably, as best seen in FIGS. 4 and 9, the upstanding sidewall 22 and the leg cover shelves 50 are hollow and include internal passageways 54. The internal passageways 54 are configured such that the jet conduits 32 can be routed therethrough for connecting the sidewall leg jet nozzles 26SL and the leg cover jet nozzles 26LC to the water pump unit 28.

The spa bath 10 preferably also includes sidewall leg jet nozzles 26SL which are mounted along the longitudinal corner sections 56u, 56l formed between the sidewall 22 and the floor section 16 and between the sidewall 22 and the leg cover shelves 50. Specifically, as best seen in FIGS. 2 and 9, the sidewall leg jet nozzles 26SL mounted along the lower corner sections 56l formed between sidewall 22 and the floor section 16 are preferably positioned to direct massaging water jets upwardly at an angle towards the back and outer sides of the spa bath user's legs. The sidewall leg jet nozzles 26SL mounted along the upper corner sections 56u formed between sidewall 22 and the leg cover shelves 50 are preferably positioned to direct massaging water jets downwardly at an angle towards the front and outer sides of the spa bath user's legs.

Preferably, the body 12 also includes an inner leg jet wall 58 extending upwardly from the floor section 16 and horizontally inwardly from the body foot end 12f towards the floor inboard end 16ie. The inner leg jet wall 58 extends along the approximate longitudinal centerline of the body 12 and is configured to be positioned between the bath user's calves (see FIG. 5). Like the leg cover shelves 50, the inner leg jet wall 58 includes a plurality of jet nozzles 26 mounted thereto (referred to hereinafter as the inner leg jet nozzles 26IL) which are positioned to direct massaging water jets towards the inner sides of the spa bath user's legs. Specifically, a plurality of inner leg jet nozzles 26IL are mounted on either side of the inner leg jet wall 58 preferably along the longitudinal corner sections 60c formed between the leg jet wall 58 and the floor section 16. The inner leg jet nozzles 26IL are preferably positioned to direct massaging water jets upwardly at an angle towards the inner sides of the spa bath user's legs. Additionally, like the leg cover shelves 50, the inner leg jet wall 58 is preferably hollow and includes internal passageways 54 whereat the conduits can be routed for connecting the inner leg jet nozzles 26IL to the water pump unit 28.

As should now be appreciated, the floor jet nozzles 26F, the leg cover jet nozzles 26LC, the sidewall leg jet nozzles 26SL, and the inner leg jet nozzles 26IL substantially surround the spa bath user's legs and allow the spa bath 10 to apply hydromassage therapy to the front, back, and both sides of the bath user's legs simultaneously. In this regard, traditional therapeutic spa baths are typically configured to apply hydromassage therapy to one side of the spa bath user's body at a time and required the spa bath user to reposition themselves for applying hydromassage therapy to the other sides of their body. In the present invention, providing jet nozzles 26 which can be used for simultaneously applying hydromassage therapy to the front, back, and both sides of the bath user's legs eliminates this need for the spa bath user to reposition during the hydromassage therapy treatment.

Preferably, as best seen in FIG. 9, the spa bath 10 also includes a plurality of jet nozzles 26 (referred to hereinafter as the sidewall foot jet nozzles 26SF) which are mounted to the foot end surface 23f of the upstanding sidewall 22. The sidewall foot jet nozzles 26SF are positioned vertically between the floor section 16 and the leg cover shelves 50 and horizontally between the sidewall longitudinal side surfaces 23a, 23b whereat the sidewall leg jet nozzles 26 are mounted and the inner leg jet wall 58. The sidewall foot jet nozzles 26SF can be arranged in, for example, staggered rows and columns and are positioned to direct massaging water jets towards the soles of the spa bath user's feet for providing a relaxing foot massage.

As best seen in FIGS. 3A, 4, 5, and 8, the spa bath 10 preferably also includes a pair of armrest platforms 62 that are formed one on either side of the reservoir 24 and a pair of arm cover shelves 64 that extend horizontally from the sidewall longitudinal side surfaces 23a, 23b and are located vertically above the armrest platforms 62. The armrest platforms 62 and arm cover shelves 64 can be integrally formed with or attached to the body 12 and, together with the sidewall 22, define a pair of C-shaped arm receiving channels 66.

The armrest platforms 62 and the arm cover shelves 64 each include a plurality of jet nozzles 26 mounted thereto (referred to hereinafter as the armrest jet nozzles 26AR and the arm cover jet nozzles 26AC, respectively) which can be arranged in, for example, regularly spaced rows and columns. Like the leg cover shelves 50 and the inner leg jet wall 58, the arm cover shelves 64 are preferably hollow and include internal passageways 54 whereat the conduits can be routed for connecting the arm cover jet nozzles 26AC to the water pump unit 28.

In use, the spa bath user's arms are received one into each of the C-shaped arm receiving channels 66 and the armrest jet nozzles 26AR and arm cover jet nozzles 26AC are used to provide hydromassage therapy to the user's arms and shoulders. Specifically, the armrest jet nozzles 26AR are positioned to direct massaging water jets towards the back and inner sides of the spa bath user's arms and the arm cover jet nozzles 26AC are positioned to direct massaging water jets towards the front of the spa bath user's arms and shoulders. Additionally, a plurality of jet nozzles 26 (referred to hereinafter as the sidewall arm jet nozzles 26SA) are mounted to the sidewall 22 in the spaces between the armrest platforms 62 and arm cover shelves 64. The sidewall arm jet nozzles 26SA are positioned to direct massaging water jets towards the outer sides of the spa bath user's arms and shoulders.

Preferably, sidewall arm jet nozzles 26SA are mounted along the longitudinal corner sections 68u, 68l formed between the sidewall 22 and the armrest platforms 62 and between the sidewall 22 and the arm cover shelves 64. The sidewall arm jet nozzles 26SA mounted along the lower corner sections 68l formed between sidewall 22 and the armrest platforms 62 are preferably positioned to direct massaging water jets upwardly at an angle towards the outer sides of the spa bath user's arms. The sidewall arm jet nozzles 26SA mounted along the lower corner sections 68u formed between the sidewall 22 and the arm cover shelves 64 are preferably positioned to direct massaging water jets downwardly at an angle towards the outer sides of the spa bath user's arms.

Preferably, as best seen in FIG. 8, the arm cover shelves 64 also include curved, L-shaped wall portions 70 which extend along the longitudinal edge of the arm cover shelves 64 opposite the sidewall 22. A plurality of jet nozzles 26 (referred to hereinafter as the inner arm jet nozzles 26IA) are mounted to the curved wall portions 70 and are positioned to direct massaging water jets downwardly at an angle towards the front and inner sides of the spa bath user's arms and shoulders. Like the jet nozzles 26 used for providing hydromassage therapy to the spa bath user's legs, the armrest jet nozzles 26AR, arm cover jet nozzles 26AC, sidewall arm jet nozzles 26SA, and inner arm jet nozzles 26IA are used to provide hydromassage therapy to the front, back, and both sides of the bath user's arms and shoulders simultaneously.

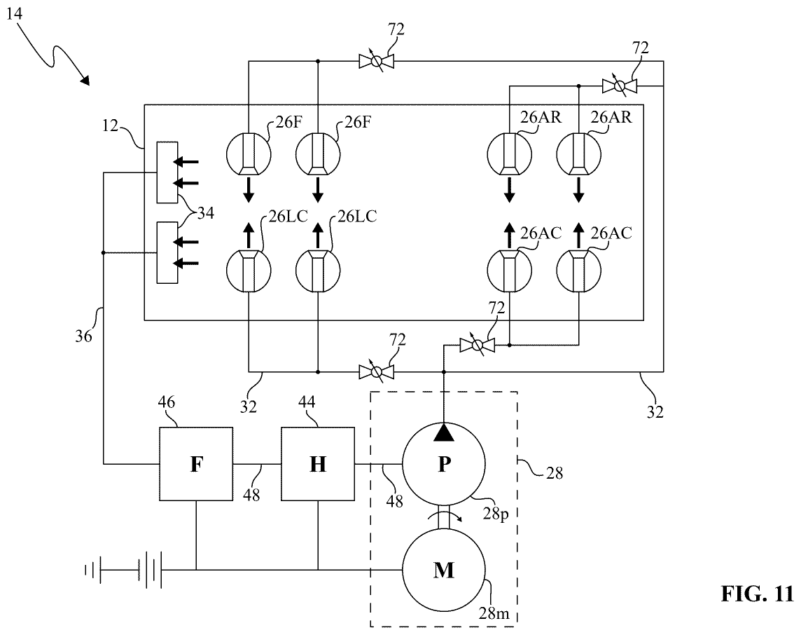

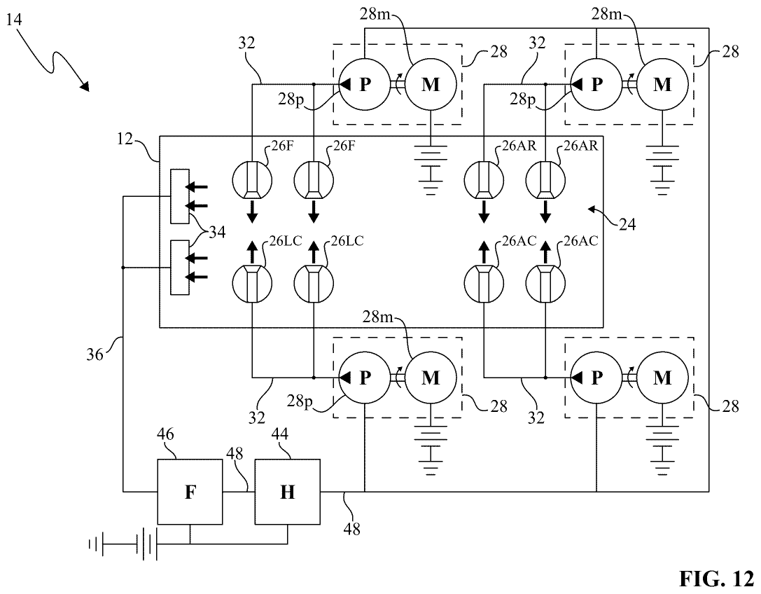

Turning to FIGS. 11 and 12, the massaging jet system 14 is preferably configured to be selectively controlled by the spa bath user for applying hydromassage therapy to selectively desired portions of the spa bath user's body. For example, the massaging jet system 14 is preferably configured such that, if the spa bath user wants to apply hydromassage therapy to their legs but not to their arms, the spa bath user can selectively engage the massaging jet system 14 for providing pressurized water to the jet nozzles 26 which target the user's legs (i.e., the floor jet nozzles 26F, the sidewall leg jet nozzles 26SL, the leg cover jet nozzles 26LC, and the inner leg jet nozzles 26IL), but not to the jet nozzles which target the user's arms (i.e., the armrest jet nozzles 26AR, arm cover jet nozzles 26AC, sidewall arm jet nozzles 26SA, and inner arm jet nozzles 26IA).

Of course, this can be accomplished in a number of ways. For example, as diagrammatically shown in FIG. 11, the massaging jet system 14 can include one or more control valves 72 which are connected between the water pump unit 28 and the jet nozzles 26. The control valves 72 can be used for selectively controlling the flow of water to each group of jet nozzles 26 and thereby selectively controlling the activation and intensity of the massaging water jets generated by said jet nozzles 26.

Alternatively, as diagrammatically shown in FIG. 12, the massaging jet system 14 can include a plurality of water pump units 28 whereby each water pump unit 28 is connected to a single group of jet nozzles 26. In this embodiment, the water pump units 28 can be selectively, individually activated for selectively providing pressurized water to the desired groups of jet nozzles 26. Additionally, as mentioned above, the massaging jet system 14 preferably uses water pump units 28 that can be selectively controlled for selectively increasing and/or decreasing the output pressure thereof and thereby selectively increasing and/or decreasing the intensity of the massaging water jets. Using a plurality of such water pump units 28 allows the spa bath user to not only selectively activate certain groups of jet nozzles 26, but also to selectively control the intensity of the massaging water jets generated by those jet nozzles 26 and, hence, the intensity of the hydromassage therapy provided to each portion of their body.

While this invention has been described as having an exemplary design, the present invention may be further modified within the spirit and scope of this disclosure. For example, the leg cover shelves 50 and the arm cover shelves 64 are shown as being generally rectangular. However, it should be understood that the leg and arm cover shelves 50, 64 can be other shapes as may be necessary or desirable. This application is therefore intended to cover any variations, uses, or adaptations of the invention using its general principles.

What is claimed is:

1. A method of providing a spinal traction/decompression therapy treatment using a therapeutic spa bath, the therapeutic spa bath comprising:
a bathtub body having a floor, a backrest, a headrest, an upstanding sidewall, and a reservoir defined between the floor, backrest, headrest, and upstanding sidewall, said reservoir filled with water;
a first plurality of water jet nozzles mounted to the backrest;
a second plurality of water jet nozzles mounted to the headrest; and
a water pump operably coupled to the first and second pluralities of water jet nozzles by one or more conduits;
wherein the water pump provides pressurized water to the first and second pluralities of water jet nozzles through the conduits for generating massaging water jets within the reservoir;
the method comprising the steps of:
positioning a spa bath user within the reservoir, the spa bath user having a torso, a head, arms, and legs, wherein the spa bath user's head is positioned adjacent to the headrest and the spa bath user's torso is positioned adjacent to the backrest; and
activating the water pump for generating massaging water jets within the reservoir;
wherein the massaging water jets generated by the first plurality of water jet nozzles gently pull the spa bath user's torso in a first direction and the second plurality of water jet nozzles gently pull the spa bath user's head an opposite second direction for providing a gentle spinal traction/decompression therapy treatment.

2. The method of claim 1, wherein the spa bath user is floatingly supported within the reservoir and experiences reduced gravitational forces which facilitates the spinal traction/decompression therapy treatment.

3. The method of claim 1, wherein the therapeutic spa bath further comprises a water heater unit operably coupled to the water pump by one or more conduits, said water heater unit in fluid communication with the reservoir, and wherein the water heater unit heats the water contained within the reservoir for providing a heat therapy treatment.

4. A therapeutic spa bath for providing a spa bath user having a torso, a head, arms, and legs with a spinal traction/decompression therapy treatment, the therapeutic spa bath comprising:
a bathtub body having a floor, a backrest, a headrest, an upstanding sidewall, and a reservoir defined between the floor, backrest, headrest, and upstanding sidewall, said reservoir filled with water;
a first plurality of water jet nozzles mounted to the backrest;
a second plurality of water jet nozzles mounted to the headrest; and
a water pump operably coupled to the first and second pluralities of water jet nozzles by one or more conduits;
wherein the water pump provides pressurized water to the first and second pluralities of water jet nozzles through the conduits for generating massaging water jets within the reservoir;
wherein the spa bath user is positioned within the reservoir with the spa bath user's head adjacent to the headrest and the spa bath user's torso adjacent to the backrest; and
wherein the massaging water jets generated by the first plurality of water jet nozzles gently pull the spa bath user's torso in a first direction and the second plurality of water jet nozzles gently pull the spa bath user's head an opposite second direction for providing a gentle spinal traction/decompression therapy treatment.

5. A therapeutic spa bath for providing one or more hydrotherapy treatments, the therapeutic spa bath comprising:
a floor;
a backrest;
a headrest;
an upstanding sidewall;
a reservoir defined between the floor, upstanding sidewall, backrest, and headrest, said reservoir filled with water;
a pair of leg cover shelves extending over the floor adjacent to a first end of the therapeutic spa bath;
a plurality of water jet nozzles, wherein one or more of the water jet nozzles are mounted to the floor beneath the leg cover shelves and one or more water jet nozzles are mounted to the leg cover shelves above the floor; and
a water pump operably coupled to the water jet nozzles by one or more conduits;
wherein the water pump provides pressurized water to the water jet nozzles through the conduits for generating massaging water jets within the reservoir.

6. The therapeutic spa bath of claim 5, wherein the massaging water jets generated by the water jet nozzles mounted to the leg cover shelves flow generally downwardly towards the floor and the massaging water jets generated by the water jet nozzles mounted to the floor beneath the leg cover shelves flow generally upwardly towards the leg cover shelves.

7. The therapeutic spa bath of claim 5 further comprising a pair of armrests formed one on either side of the reservoir and a pair of arm cover shelves which extend one over each of the armrests, wherein one or more water jet nozzles are mounted to each armrest and one or more water jet nozzles are mounted to each arm cover shelf.

8. The therapeutic spa bath of claim 7, wherein the water jet nozzles mounted to the armrests generate massaging water jets which flow generally upwardly towards the arm cover shelves and the water jet nozzles mounted to the arm cover shelves flow generally downwardly towards the armrests.

9. The therapeutic spa bath of claim 5, wherein one or more of the water jet nozzles are mounted to the sidewall vertically between the floor and each of the leg cover shelves.

10. The therapeutic spa bath of claim 7, wherein one or more of the water jet nozzles are mounted to the sidewall vertically between the armrest and each of the arm cover shelves.

11. The therapeutic spa bath of claim 5 further comprising a pair of armrests formed one on either side of the reservoir and a pair of arm cover shelves which extend one over each of the armrests, wherein one or more water jet nozzles are mounted to each armrest and one or more water jet nozzles are mounted to each arm cover shelf, wherein one or more of the water jet nozzles are mounted to the sidewall vertically between the floor and each of the leg cover shelves, and wherein one or more of the water jet nozzles are mounted to the sidewall vertically between the armrest and each of the arm cover shelves.

12. The therapeutic spa bath of claim 5 further comprising an inner leg jet wall which extends upwardly from the floor and extends generally longitudinally along a centerline of the reservoir, wherein one or more of the water jet nozzles are mounted to the inner leg jet wall.

13. The therapeutic spa bath of claim 12, wherein the water jet nozzles mounted to the inner leg jet wall generate massaging water jets which flow at an angle generally upwardly and horizontally towards a longitudinal side of the reservoir.

14. A method of providing a hydromassage therapy treatment using a therapeutic spa bath, the therapeutic spa bath comprising:
a floor;
a backrest;
a headrest;
an upstanding sidewall;
a reservoir defined between the floor, upstanding sidewall, backrest, and headrest, said reservoir filled with water;
a pair of leg cover shelves extending over the floor adjacent to a first end of the therapeutic spa bath;
a plurality of water jet nozzles, wherein one or more of the water jet nozzles are mounted to the floor beneath the leg cover shelves and one or more water jet nozzles are mounted to the leg cover shelves above the floor; and
a water pump operably coupled to the water jet nozzles by one or more conduits;
wherein the water pump provides pressurized water to the plurality of water jet nozzles through the conduits for generating massaging water jets within the reservoir;
the method comprising the steps of:
positioning a spa bath user within the reservoir, the spa bath user having a torso, a head, arms, and legs, wherein the spa bath user's legs are positioned between the water jet nozzles mounted to the floor and the water jet nozzles mounted to the leg cover shelves; and
activating the water pump for generating massaging water jets within the reservoir; wherein the massaging water jets generated by water jet nozzles mounted to the floor provide a hydromassage therapy treatment to a first side of the spa bath user's legs and the water jet nozzles mounted to the leg cover shelves provide a hydromassage therapy treatment to a second side of the spa bath user's legs.

15. The method of claim 14, wherein the therapeutic spa bath further comprises an inner leg jet wall which extends upwardly from the floor and extends generally longitudinally along a centerline of the reservoir, wherein one or more of the water jet nozzles are mounted to the inner leg jet wall, and wherein the massaging water jets generated by the water jet nozzles mounted to the inner leg jet wall provide a hydromassage therapy treatment to a third side of the spa bath user's legs.

16. The method of claim 14, wherein the therapeutic spa bath further comprises a pair of armrests formed one on either side of the reservoir and a pair of arm cover shelves which extend one over each of the armrests, wherein one or more water jet nozzles are mounted to each armrest and one or more water jet nozzles are mounted to each arm cover shelf, and wherein the massaging water jets generated by the water jet nozzles mounted to the armrest provide a hydromassage therapy treatment to a first side of the spa bath user's arms and the massaging water jets generated by the water jet nozzles mounted to the arm cover shelves provide a hydromassage therapy treatment to a second side of the spa bath user's arms.

17. The method of claim 14, wherein the water pump is selectively adjustable for increasing or decreasing an intensity of the massaging water jets generated within the reservoir.

18. The method of claim 16, wherein the water pump is selectively adjustable for increasing or decreasing an intensity of the massaging water jets generated by the water jet nozzles mounted to the floor, the leg cover shelves, the armrests, and the arm cover shelves independently from each other.
